(19) United States
(12) Patent Application Publication
(10) Pub. No.: US 2026/0011335 A1
(43) Pub. Date: Jan. 8, 2026

(54) NON-WINDOWED DCT-BASED AUDIO CODING USING ADVANCED QUANTIZATION

(71) Applicant: Google LLC, Mountain View, CA (US)

(72) Inventors: Jyrki Antero Alakuijala, Wollerau (CH); Moritz Firsching, Basel (CH); Sami Boukortt, Zurich (CH); Martin Bruse, Tyreso (SE); Evgenii Kliuchnikov, Thalwil (CH); Thomas Fischbacher, Gattikon (CH)

(21) Appl. No.: 19/120,438

(22) PCT Filed: Oct. 20, 2022
(86) PCT No.: PCT/US2022/078414

§ 371 Date: Apr. 11, 2025

(51) Int. Cl. G10L 19/032; G10L 19/022

(52) U.S. Cl. CPC G10L 19/032; G10L 19/022

(57) ABSTRACT

A method including receiving a time-domain audio signal, generating a blocked time-domain audio signal as a portion of the time-domain audio signal, transforming the blocked time-domain audio signal using a first non-windowed transform function to generate a first frequency-domain audio signal, transforming the first frequency-domain audio signal using a second non-windowed transform function to generate a second frequency-domain audio signal, and compressing the second frequency-domain audio signal to generate a compressed frequency-domain audio signal.

### FIELD

Embodiments relate to encoding and decoding audio.

### BACKGROUND

Communicating and/or storing audio signals is a common practice. For example, an audio signal can be streamed from a server to a user device so that a user may listen to replay of the audio signal. The audio signal can be streamed alone or together with a video stream. Audio signals can also be stored in storage media (e.g., fixed and/or portable computer memory) for later consumption.

### SUMMARY

Example implementations can enable improved compression by using back-to back DCT to eliminate the need for a windowing function and modifying quantization associated with the audio encoder and/or inverse quantization the audio decoder.

In a general aspect, a device, a system, a non-transitory computer-readable medium (having stored thereon computer executable program code which can be executed on a computer system), and/or a method can perform a process with a method including receiving a time-domain audio signal, generating a blocked time-domain audio signal as a portion of the time-domain audio signal, transforming the blocked time-domain audio signal using a first non-windowed transform function to generate a first frequency-domain audio signal, transforming the first frequency-domain audio signal using a second non-windowed transform function to generate a second frequency-domain audio signal, and compressing the second frequency-domain audio signal to generate a compressed frequency-domain audio signal.

In another general aspect, a device, a system, a non-transitory computer-readable medium (having stored thereon computer executable program code which can be executed on a computer system), and/or a method can perform a process with a method including receiving a formatted data packet including a compressed frequency-domain audio signal, generating a decompressed frequency-domain audio signal by decompressing the compressed frequency-domain audio signal, transforming the decompressed frequency-domain audio signal using a first non-windowed transform function to generate a first time-domain audio signal, transforming the first time-domain audio signal using a second non-windowed transform function to generate a second time-domain audio signal, and generating a reconstructed time-domain audio signal based on the second time-domain audio signal.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1 illustrates a block diagram of an audio encoder and decoder system according to an example implementation.

FIG. 2 illustrates a block diagram of an audio encoder system according to an example implementation.

FIG. 3 illustrates another block diagram of an audio decoder system according to an example implementation.

FIG. 4 illustrates a transform module associated with an audio encoder system according to an example implementation.

FIG. 5 illustrates a block diagram of a quantization module associated with an audio encoder system according to an example implementation.

FIG. 6 illustrates a block diagram of an inverse quantization module associated with an audio encoder system according to an example implementation.

FIG. 7 illustrates a method of compressing audio according to an example implementation.

FIG. 8 illustrates a method of de-compressing audio according to an example implementation.

FIG. 9A illustrates a block diagram of an audio encoder according to an example implementation.

FIG. 9B illustrates another block diagram of an audio decoder according to an example implementation.

It should be noted that these Figures are intended to illustrate the general characteristics of methods, and/or structures utilized in certain example embodiments and to supplement the written description provided below. These drawings are not, however, to scale and may not precisely reflect the precise structural or performance characteristics of any given embodiment and should not be interpreted as defining or limiting the range of values or properties encompassed by example embodiments. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Existing audio compression techniques convert an analog audio signal to a digital signal using a modified discrete cosine transform (MDCT). Typically, the MDCT is performed on the audio signal in such a way that adjacent transformation ranges are overlapped (e.g., overlapping windows) by, for example, 50% along the time axis in order to suppress distortion developing at a boundary portion between adjacent transformation ranges. In other words, existing audio compression techniques perform audio coding using overlapping windows, where consecutive block transforms codify the same signal twice. The overlapping windows are used to avoid a discontinuity at, for example, the block boundary. Codifying the same signal twice can be a resource (e.g., processor and memory) demanding process within the audio compression pipeline, which can be undesirable in many applications.

Example implementations described herein can reduce undesirable resource usage in audio compression by, for example, using back-to-back discrete cosine transform (DCT) transforms for audio coding without windowing (e.g., without using the aforementioned overlapping windows). In other words, a time-domain signal can be transformed to a frequency-domain signal using a first non-windowed transform function (e.g., DCT). Then the frequency domain signal can be transformed again using a second non-windowed transform function (e.g., DCT) except the frequency domain signal remains as a frequency-domain signal.

By reducing resource usage, using the techniques described herein, audio compression can be performed in less time, and/or resources can be used for other coding processes. In some implementations of the techniques described herein, additional audio channels can be compressed within a specified time-period or time-frame (e.g., requirement). Also, in some implementations of the techniques described herein, smaller compressed files can be generated, which can result in using less bandwidth to communicate, using less memory to store the compressed file, and/or the like. In some implementations of the techniques described herein, a user (e.g., using a play-back device) can receive a smaller compressed file during, for example, a streaming (e.g., receiving a formatted data packet(s)) operation. Therefore, the streaming can be faster and/or more reliable. Alternatively, a user (e.g., using a play-back device) can receive a roughly typical size compressed file during, for example, a streaming operation. Therefore, the user may receive additional audio channels which, when played back, can result in a higher quality audio, thus improving the user experience.

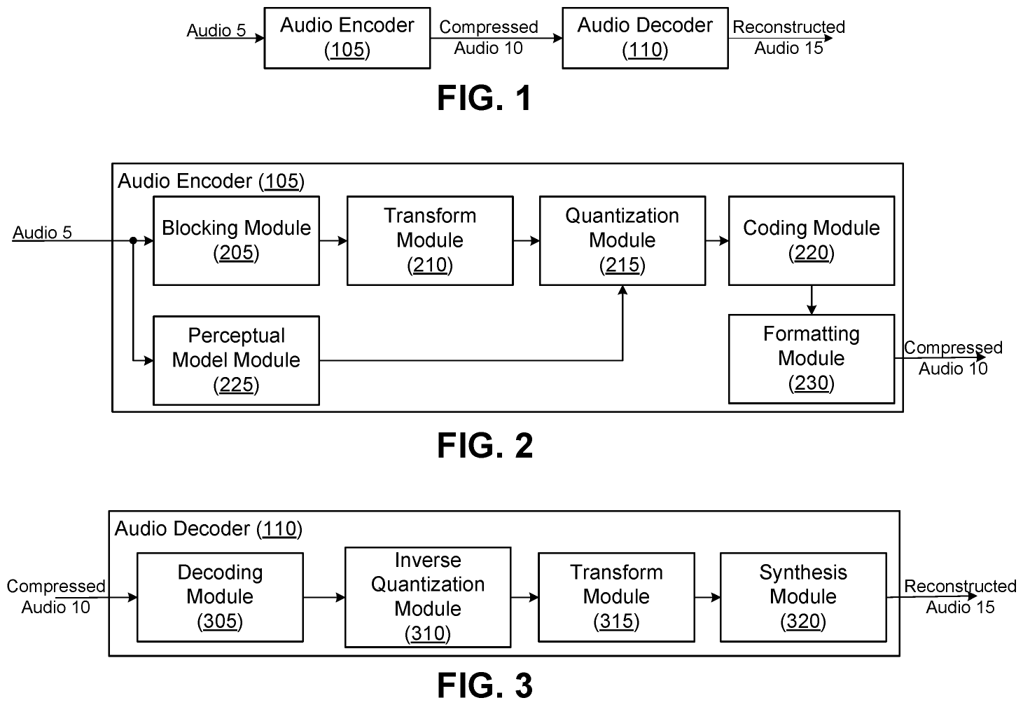

FIG. 1 illustrates a block diagram of an audio encoder and decoder system according to an example implementation. As shown in FIG. 1, the system includes an audio encoder 105 and an audio decoder 110. The audio encoder 105 can be configured to generate a compressed audio 10 signal based on an input audio 5 signal. The audio 5 signal can be an analog audio signal, a time-domain audio signal, and the like. Therefore, input audio 5 can be referred to as a time-domain audio signal. The time-domain audio 5 signal can be a live recording, a stored file of a recording, associated with a video, and/or the like. The compressed audio 10 signal can be a digital audio signal, a frequency-domain audio signal, and the like. Therefore, compressed audio 10 signal can be referred to as a compressed frequency-domain audio signal The audio decoder 110 can be configured to generate a reconstructed audio 15 signal based on the compressed frequency-domain audio 10 signal. The reconstructed audio 15 signal can be an analog audio signal, a time-domain audio signal, and the like. Therefore, reconstructed audio 15 signal can be referred to as a reconstructed time-domain audio signal The audio encoder 105 and the audio decoder 110 can be independent of each other. In other words, the audio encoder 105 can generate the frequency-domain compressed audio 10 signal which can be decompressed using a different decompression technique than that used by the audio decoder 110. Further, the audio decoder 110 can be used to decompress a compressed frequency-domain audio signal that was compressed using a different compression technique than that used by the audio encoder 105.

In example implementations, the audio encoder 105 and/or the audio decoder 110 can be configured to use properties associated with a DCT to reduce a maximum discontinuity at a block boundary to a fixed value. The maximum discontinuity at a block boundary can be based on the length of the block. For example, a property associated with the DCT can be that a signal at a first end of the block can be transformed based on the sum of the DCT coefficients. The sum of the DCT coefficients can be calculating a sum of the values of the DCT coefficients within adjacent buckets of (e.g., all, most, a portion of) the quantized frequency-domain audio signal. For example, another property associated with the DCT can be that a signal at a second end of the block can be transformed based on an alternating sum of DCT coefficients. An alternating sum of DCT coefficients can be calculating a sum of the values of the DCT coefficients within every other bucket of the quantized frequency-domain audio signal. In addition, the properties of the DCT apply to the derivates of the signal within the block. For example, odd derivates can be zero at the block boundary. Further, the even derivates of the signal within the block (e.g., second derivate, fourth derivate, etc.) can be controlled because the even derivates are cosine functions.

Therefore, the encoder 5 can be configured to receive a time-domain audio signal (e.g., audio 5) and the encoder 5 can be configured to generate a blocked time-domain audio signal. The blocked time-domain audio can be a portion of the time-domain audio signal (e.g., audio 5). As mentioned above, the encoder 5 can be configured to use properties associated with a DCT. The properties associated with a DCT can be used to transform the blocked time-domain audio from the time-domain to the frequency-domain without using windowing. Accordingly, the encoder 5 can be further configured to transform the blocked time-domain audio signal using a first non-windowed transform function (e.g., a DCT) to generate a first frequency-domain audio signal and transform the first frequency-domain audio signal using a second non-windowed transform function (e.g., a DCT) to generate a second frequency-domain audio signal. The audio encoder 5 can then compress (e.g., quantize and entropy encode) the second frequency-domain audio signal to generate a compressed frequency-domain audio signal (e.g., compressed audio 10). The compressed frequency-domain audio signal (e.g., compressed audio 10) can be stored in a computer memory, streamed (e.g., communicating a formatted data packet(s) to a remote device) for playing back on a play-back device), and/or the like.

The audio decoder 110 can also be configured to use properties associated with a DCT. The properties associated with a DCT can be used to transform the compressed frequency-domain audio signal (e.g., compressed audio 10) from the frequency-domain to the time-domain without using windowing. Accordingly, the audio decoder 110 can be configured to receive a formatted data packet including a compressed frequency-domain audio signal (e.g., compressed audio 10) and generate a decompressed frequency-domain audio signal by decompressing (e.g., inverse-entropy encoding and inverse-quantizing) the compressed frequency-domain audio signal. The audio decoder 110 can further be configured to transform the decompressed frequency-domain audio signal using a first non-windowed transform function (e.g., an IDCT) to generate a first time-domain audio signal and transform the first time-domain audio signal using a second non-windowed transform function (e.g., an IDCT) to generate a second time-domain audio signal. The audio decoder 110 can then generate a reconstructed time-domain audio signal (e.g., reconstructed audio 15) based on the second time-domain audio signal. A user can then listen to (e.g., by playing back on a play-back device) the reconstructed time-domain audio signal.

FIG. 2 illustrates a block diagram of an audio encoder system according to an example implementation. As shown in FIG. 2, the audio encoder 105 includes an analysis and blocking module 205 block, a transform module 210 block, a quantization module 215 block, a coding module 220 block, a perceptual model module 225 block and a formatting module 230 block. In example implementations, the audio encoder 105 can be configured to reduce discontinuities at, for example, the block boundary without using a window(s) using a DCT.

The blocking module 205 can be configured to sample the input time-domain audio 5 signal in sequential temporal frames, each frame can include a portion of the input time-domain audio 5 signal sometimes called a blocked time-domain audio signal based on the input time-domain audio 5 signal. The analysis and blocking module 205 can be configured to preprocess the input time-domain audio 5 signal. The preprocessing can include normalization, frequency weighting, frequency scaling, block sorting, dynamic range scaling, and/or the like.

The transform module 210 can be configured to generate a frequency-domain audio signal by transforming a block of the input time-domain audio 5 signal (as a blocked time-domain audio signal) from analog (or time-domain) to digital (or frequency-domain). The transform module 210 can include an analog-to-digital converter (ADC). The ADC can use a Fourier transform (e.g., DCT, DFT, FFT). The ADC can be defined by an audio codec. Often the ADC has an associated bandwidth (or configurable bandwidth). The bandwidth can be the number of times per second the input time-domain audio 5 signal (e.g., as an analog source) is sampled and transformed to generate discrete digital (or frequency-domain) values by the transform module 210. In an example implementation, the transform module 210 uses a DCT. In an example implementation, the transform module 210 uses two or more DCTs. The first DCT can be configured to generate scalar values which are the analog or frequency-domain magnitudes (without phase information) of the time-domain audio 5 signal. The second DCT can be configured to generate the derivative(s) of the scalar values. The derivative(s) of the scalar values (also a frequency domain audio signal), referred to as coefficients, can be quantized to generate a quantized frequency-domain audio signal and coded to generate a compressed frequency-domain audio signal.

The quantization module 215 can be configured to generate quantized frequency-domain audio signal by quantizing the transformed audio. Quantization can be the process of mapping input values from a large set (e.g., a continuous set) of values to values in a smaller set of values with a finite number of elements (associated with the values). The elements of the smaller set are sometimes referred to as buckets where each bucket represents a range of values. For example, the quantization module 215 can be configured to quantize the coefficients, compute the errors associated with the quantized coefficients, order the quantization coefficients by the amount of error, and reposition the quantization coefficients based on the error. The quantization coefficients can be repositioned (e.g., moved to a different bucket) until the error is within a threshold range. The repositioning of the quantization coefficients can reduce discontinuities at, for example, the block boundary by reducing the errors associated with the quantized coefficients.

The coding module 220 can be configured to generate a compressed frequency-domain audio signal (e.g., compressed audio 10) by entropy encoding the quantized frequency-domain audio signal. Entropy encoding the quantized frequency-domain audio signal can include creating and assigning a unique prefix-free code to each unique quantized coefficient or quantization level corresponding to the quantized frequency-domain audio signal. Entropy encoding can include compressing data by replacing each quantized coefficient or quantization level with the corresponding variable-length prefix-free output codeword to generate the compressed audio signal.

The perceptual model module 225 can be configured to analyze the input time-domain audio 5 signal and determine relevant perceptual signal aspects, most notably the signal's masking ability (e.g., masking threshold) as a function of frequency and time. The result is communicated to the quantization module 215 to control coding distortion to render the distortion substantially inaudible. The perceptual model module 225 can use psychoacoustic criteria, such as masking thresholds, for the quantization of the transformed audio in order to maximize audio quality as perceived by human listeners. For example, the perceptual model module 225 can generate a perceptually shaped spectral distortion profile that provides improved subjective audio quality at the expense of the noise-based quality measures.

The formatting module 230 can be configured to generate a formatted data packet or file including a compressed frequency-domain audio signal (e.g., compressed audio 10). The formatted data packet or file can be formatted based on the codec. For example, the formatted file can be formatted to the opus, mp3, ambisonic, advanced audio coding (AAC), and the like audio file format.

FIG. 3 illustrates a block diagram of an audio decoder system according to an example implementation. As shown in FIG. 3, the audio decoder 110 includes a decoding module 305 block, an inverse quantization module 310 block, a transform module 315 block, and a synthesis module 320 block. In an example implementation, the audio decoder 110 can be configured to decode the compressed frequency-domain audio signal (e.g., compressed audio 10) without windowing.

The decoding module 305 can be configured to perform the opposite operation of the coding module 220. The decoding module 305 can be configured to generate a decompressed frequency-domain audio signal. In other words, the decoding module 305 can be configured to inverse entropy code the compressed audio 10.

The inverse quantization module 310 can be configured to perform the opposite operation of the quantization module 215. The inverse quantization module 310 can be configured to generate an inverse-quantized frequency-domain audio signal based on the decompressed frequency-domain audio signal. In an example implementation, the inverse quantization module 310 can be configured to calculate the alternating sums (e.g., the number of quantized transform coefficients in alternating buckets) of a previous block and reposition the sum of the current block towards the alternating sum of the previous block (within the quantization boundaries). The repositioning can be configured to generate bandwidth limited or frequency response manipulated continuities at the block boundary.

The transform module 315 can be configured to perform the opposite operation of the transform module 210. For example, the transform module 315 can be configured to generate a time-domain audio signal by inverse-transforming the inverse-quantized frequency-domain audio signal from digital (or frequency-domain) to analog (or time-domain). The transform module 210 can include a digital-to-analog converter (DAC). The DAC can use an inverse Fourier transform (e.g., IDCT, IDFT, IFFT). The DAC can be defined by an audio codec. In an example implementation, the transform module 315 uses an IDCT. In an example implementation, the transform module 315 uses two or more IDCTs. The first IDCT can be configured to generate integrated scalar values (e.g., in the time-domain) associated with the inverse-quantized frequency-domain audio signal. The second IDCT can be configured to generate scalar values (e.g., in the time-domain) which are the analog or time-domain magnitudes associated with (e.g., as a block or frame of) a reconstructed time-domain audio signal (e.g., reconstructed audio 15).

The synthesis module 320 be configured to generate the reconstructed time-domain audio signal (e.g., reconstructed audio 15). For example, the synthesis module 320 be configured to combine adjacent blocks of time-domain audio into a continuous output audio signal as the reconstructed time-domain audio signal (e.g., reconstructed audio 15).

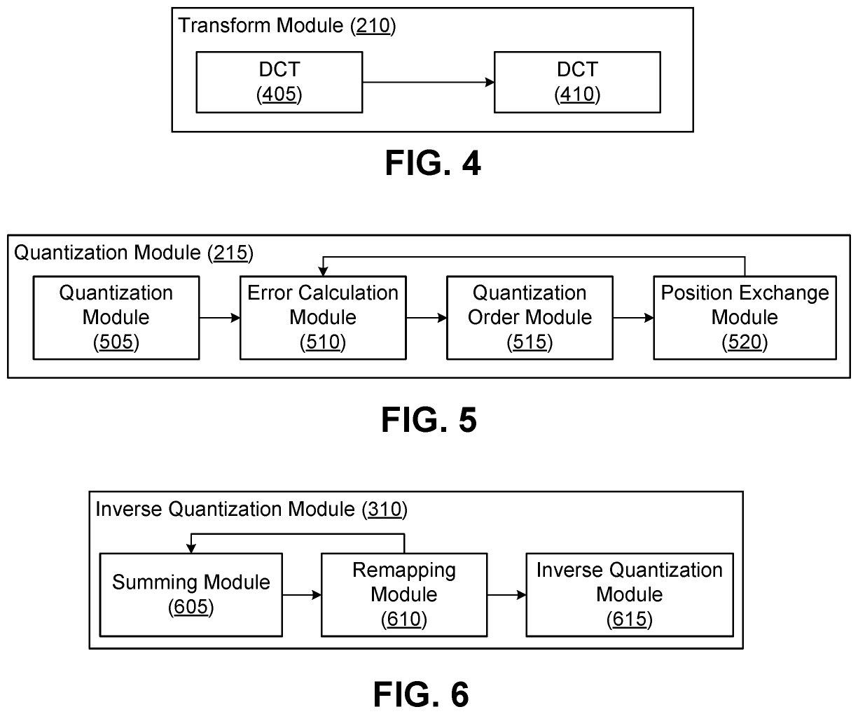

FIG. 4 illustrates a transform module associated with an audio encoder system according to an example implementation. As shown in FIG. 4, the transform module 210 includes a DCT 405 (e.g., a first non-windowed transform function or DCT) block and a DCT 410 (e.g., a second non-windowed transform function or DCT) block. The DCT 405 and the DCT 410 together can transform the time-domain audio 5 signal (a portion of time-domain audio 5 signal or a block of time-domain audio 5 signal, and/or the like) without windowing the time-domain audio 5 signal. The DCT 410 can be configured to generate the coefficients (e.g., in the frequency-domain) that will be quantized as a quantized frequency-domain audio signal.

The DCT 405 can be configured to generate scalar values (e.g., digital or frequency-domain) which are the analog or time-domain magnitudes (without phase information) of the time-domain audio 5 signal. The DCT 405 can be configured to generate the derivative(s) of the scalar values (e.g., as quantized frequency-domain audio signal). The derivative(s) of the scalar values, referred to as coefficients, can be quantized and coded. DCT 405 can be expressed as shown in eqn. (1).

$$C ( μ ) = α ( μ ) {\sum }_{t = 0}^{N - 1} cos [ \frac{π μ}{2 N} ] ( 2 t + 1 ) f ( t ) \qquad ( 1 )$$

where:
N is the length of the signal (e.g., the block size);
μ is the frequency being evaluated;
C(0, . . . N−1) is the transform coefficient; and

$$α ( μ ) = \{ \sqrt{\frac{1}{N} for μ = 0} , \sqrt{\frac{2}{N} for μ > 0} , .$$

Eqn. (1) can be simplified as shown in eqn. (2).

$$C ( μ ) = {\sum }_{n = 0}^{N - 1} {x}_{n} \times cos 2 πμ n \div N \qquad ( 2 )$$

where:
n is the index of the current value in the signal; and
xₙ is the value at that index.

DCT 410 can be the derivative of eqn. (2) and expressed as shown in eqn. (3).

$$\frac{{dX}_{k}}{{dx}_{m}} = cos ( 2 π km \div N ) \qquad ( 3 )$$

where m is an index and all terms of the sum go to zero as constants except for the one involving index m.

FIG. 5 illustrates a block diagram of a quantization module associated with an audio encoder system according to an example implementation. As shown in FIG. 5, the quantization module 215 can include a quantization module 505 block, an error calculation module 510 block, a quantization order module 515 block, and a position exchange module 520 block.

In an example implementation, the quantization module 215 can be configured to selecting a transform coefficient from a first bucket as a first mapped position, identify a second bucket adjacent to the first bucket as a second mapped position (e.g., to a bucket with a proximate value range as the first bucket), and map the transform coefficient to the second bucket. The selecting of the transform coefficient can be based on an error associated with the quantized transform coefficient value corresponding to the transform coefficient. The mapping of the transform coefficient to the second bucket can include repeatedly selecting a transform coefficient and/or mapping (or remapping) the transform coefficient to the second bucket until a sum of errors is less than a threshold value. In other words, operating the error calculation module 510, the quantization order module 515, and the position exchange module 520 repeatedly (e.g., over and over) until a sum of errors is less than a threshold value. The mapping of the transform coefficient to the second bucket can include identifying a subset of a plurality of quantized transform coefficient values, identifying the first bucket as within the subset of the plurality of quantized transform coefficient values, and the second bucket can be within the subset of the plurality of quantized transform coefficient values.

The quantization module 505 can be configured to a generate quantized frequency-domain audio signal by quantizing the transform coefficients as generated by the DCT 410. The quantization module 505 can be configured to reduce the number of bits used to represent the transform coefficients as generated by the DCT 410. Quantization can be the process of mapping input values from a large set (e.g., a continuous set) of values to values in a smaller set of values with a finite number of elements (associated with the values). The elements of the smaller set are sometimes called buckets where each bucket represents an energy band (e.g., a range of values). Therefore, the quantization module 505 can be configured to map the transform coefficients as generated by the DCT 410 to a bucket representing a range of transform coefficient scalar values. The quantization module 505 can be configured to reduce the error in sum and alternating sum of each bucket by introducing a small amount error into each quantization decision resulting in a transform coefficient being mapped to a bucket. Each energy band can have a better continuity at a block boundary if the introduced error is varied based on the order of the coefficients. In an example implementation, the quantization errors can be modified by adjusting the quantization of near-by frequencies resulting in maximizing continuity at block boundaries.

The error calculation module 510 is configured to calculate a quantization error associated with the quantized transform coefficients. Quantizing a sequence of numbers produces a sequence of quantization errors. Allocating more bits to each frequency can cause less error (noise) to be introduced, but more space is required to store the result. Conversely, fewer bits allocated to each frequency results in more noise, but less space is required to store the result. In an example implementation, quantization error can be the difference between a quantized transform coefficient value (e.g., the value range assigned to a bucket) and the transform coefficient value. The error calculation module 510 can be configured to calculate the error sum for each bucket. The error calculation module 510 can be configured to calculate the error sum of all buckets and the error sum of alternating buckets.

The quantization order module 515 can be configured to order the quantized transform coefficient values based on the amount of error each quantized transform coefficient value introduces. The position exchange module 520 can be configured to map a transform coefficient to an adjacent bucket (e.g., to a bucket with a proximate value range). For example, a transform coefficient can be mapped (or assigned) to an adjacent bucket if the transform coefficient has the most associated error. Then processing returns to the error calculation module 510. Processing can end (or quantization be complete if the error sum of all buckets and the error sum of alternating buckets is below a threshold value, above a threshold value or within a threshold range. The threshold value and/or the threshold range can be preconfigured.

FIG. 6 illustrates a block diagram of an inverse quantization module associated with an audio encoder system according to an example implementation. As shown in FIG. 6, the inverse quantization module 310 can include a summing module 605 block, a remapping module 610 block, and an inverse quantization module 615 block.

The summing module 605 can be configured to calculate an alternating sum of a first block and an alternating sum of a second block. The first block can be a previous block and the second block can be a current block. Alternating sums can be stored in a memory associated with the summing module to form a queue. For example, the alternating sum of the second block can be stored in the memory to be used when inverse-quantizing a third (e.g., next) block. The first (e.g., previous) block, the second (e.g., current) block, and the third (e.g., next) block can be sequential (e.g., in time) blocks. In an example implementation, the alternating sum can be a sum of the number of quantized transform coefficients in alternating buckets.

The remapping module 610 can be configured to remap a quantized transform coefficient(s) from a first bucket to a second bucket. For example, the remapping module 610 can be configured to compare the alternating sum of the first block with the alternating sum of the second block. If the sum is within a threshold value, processing can continue to the inverse quantization module 615. Otherwise, a quantized transform coefficient(s) of the second block can be remapped from a first bucket to a second bucket and processing can return to the summing module where the alternating sum of the second block can be recalculated. In other words, the operating the summing module 605 and the remapping module repeatedly (e.g., over and over) until a summing delta is less than a threshold value. The remapping can be configured to generate bandwidth limited or frequency response manipulated continuities at the block boundary. For example, the first bucket and the second bucket can be within a range of buckets (e.g., within a frequency range). In this implementation, the alternating sum of the first block with the alternating sum of the second block can be limited to the range of buckets. The remapping module 610 can be configured to operate (e.g., to remap quantized transform coefficient(s)) within a quantization boundary. The quantization boundary can be the minimum range of values and the maximum range of values assigned to the buckets. In other words, the mapping associated with the quantization can be limited to be within the minimum range of values and the maximum range of values.

In an example implementation, the elements (e.g., buckets) of every second (e.g., every other) block can be reversed. Then the sums of two blocks can be matched when the corresponding low ends (of the block) are meeting, and the alternating sums when the corresponding long ends are meeting.

TABLE 1

| | 1^{st} Block | 2^{nd} Block | 3^{rd} Block | 4^{th} Block | 5^{th} Block |
|---|---|---|---|---|---|
| Initial Order | C0, C1, C2, | C0, C1, C2, | C0, C1, C2, | C0, C1, C2, | C0, C1, C2, |
| | C3, C4, C5, | C3, C4, C5, | C3, C4, C5, | C3, C4, C5, | C3, C4, C5, |
| | C6, C7 | C6, C7 | C6, C7 | C6, C7 | C6, C7 |
| Reversed | C0, C1, C2, | C7, C6, C5, | C0, C1, C2, | C7, C6, C5, | C0, C1, C2, |
| Order | C3, C4, C5, | C4, C3, C2, | C3, C4, C5, | C4, C3, C2, | C3, C4, C5, |
| | C6, C7 | C1, C0 | C6, C7 | C1, C0 | C6, C7 |

Referring to Table 1, the initial element (eight (8) elements are shown, but can be many more, e.g., 1024) order of each block is C0, C1, C2, C3, C4, C5, C6, C7, where C0, . . . , C7 represent elements (e.g., buckets) of a respective bucket. The reversed element order shows every second block (e.g., the 2^{nd} Block and the 4^{th} Block) order reversed. The low ends of the block meeting can be when C0 is the last element and first element of consecutive blocks (e.g., the 2^{nd} and 3^{rd} blocks). The long ends of the block meeting can be when C7 is the last element and first element of consecutive blocks (e.g., the 1^{st} and 2^{nd} blocks).

In an example implementation, the alternating sums of the 1st block and the 2nd block can be matched, the sums of 2nd block and 3rd block can be matched, the alternating sums of the 3rd block and the 4th block can be matched, the sums of 4th block and 5th block can be matched, and so forth. As discussed above, matching blocks (by the remapping module 610) can include repeatedly remapping values of the second block of the consecutive blocks, the sum (or alternating sums) of the second block is within a threshold value of the sum (or alternating sum) of the first block of the consecutive blocks.

The inverse quantization module 615 can be configured to generate inverse-quantized frequency-domain audio signal by performing the opposite function of the quantization module 505. For example, the inverse quantization module 615 can be configured to map a quantized transform coefficient value to a transform coefficient value. For example, each bucket can have an associated transform coefficient value such that the quantized transform coefficient(s) associated with the bucket can be mapped to the transform coefficient value.

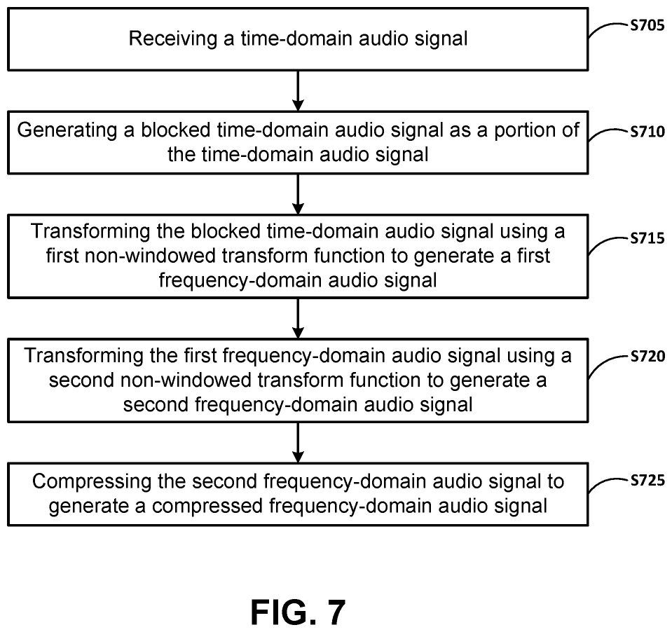

FIG. 7 illustrates a method of compressing audio according to an example implementation. As shown in FIG. 7, in step S705 a time-domain audio signal is received. In step S710 a blocked time-domain audio signal is generated as a portion of the time-domain audio signal. The time-domain audio signal can be processed into a block-based audio signal. A block-based audio signal can include samples (e.g., blocks) of the time-domain audio signal. The samples can be sequential temporal frames, each frame can include a portion of the time-domain audio signal.

In step S715 the blocked time-domain audio signal is transformed using a first non-windowed transform function to generate a first frequency-domain audio signal. The transforming can be based on an analog-to-digital converter (ADC). The ADC can use a Fourier transform (e.g., DCT, DFT, FFT). The ADC can be defined by an audio codec. For example, the ADC can be a direct ADC, a successive approximation ADC, a sigma-delta ADC, a pipelined ADC, a ramp-compare ADC, a Wilkinson ADC, an integrating ADC, and the like to name a few. In an example implementation, the first non-windowed transform function can be a DCT (e.g., a first DCT, a first non-windowed DCT, and the like).

In step S720 the first frequency-domain audio signal is transformed using a second non-windowed transform function to generate a second frequency-domain audio signal. In an example implementation, the second non-windowed transform function can be a DCT (e.g., a second DCT, a second non-windowed DCT, and the like). The transforming can find a derivative of the first frequency-domain audio signal. The first frequency-domain audio signal can include a plurality of scalar values. The DCT can be configured to generate the derivative(s) of the scalar values.

In step S725 the second frequency-domain audio signal is compressed to generate a compressed frequency-domain audio signal. In an example implementation, prior to compressing, the second frequency-domain audio signal can be quantized to generate a quantized frequency-domain audio signal. Compressing the second frequency-domain audio signal can include entropy encoding the second frequency-domain audio signal and/or the quantized frequency-domain audio signal. Entropy encoding the frequency-domain (e.g., digital) audio signal and/or the quantized digital audio signal can include creating and assigning a unique prefix-free code to each unique frequency-domain level, quantized coefficient or quantization level corresponding to the quantized digital audio signal. Entropy encoding can include compressing data by replacing each frequency-domain level, quantized coefficient or quantization level with the corresponding variable-length prefix-free output codeword to generate the compressed audio signal.

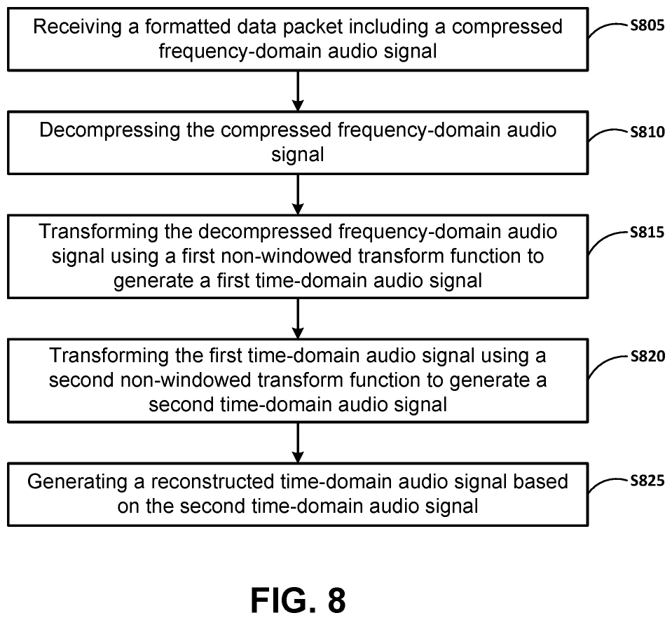

FIG. 8 illustrates a method of de-compressing audio according to an example implementation. As shown in FIG. 8, in step S805 a formatted data packet including a compressed frequency-domain audio signal is received. The formatted file can be formatted based on the codec. For example, the formatted file can be formatted to the opus, mp3, ambisonic, AAC, ASF, and the like audio file format. The formatted file can include the compressed frequency-domain audio signal and the power coefficient. In step S810 the decompressed frequency-domain audio signal is decompressed. For example, the frequency-domain audio signal can be inverse-entropy decoded and an inverse-quantization can be performed on the inverse-entropy decoded frequency-domain audio signal.

In step S815 the compressed frequency-domain audio signal is transformed using a first non-windowed transform function to generate a first time-domain audio signal. The first non-windowed transform function can be an IDCT. The IDCT (e.g., a first IDCT, a first non-windowed IDCT, and the like) can be configured to generate scalar values based on an integration of the frequency-domain audio signal. Accordingly, the first time-domain audio signal can include a plurality of scalar values.

In step S820 the first time-domain audio signal is transformed using a second non-windowed transform function to generate a second time-domain audio signal. The transform can be a digital-to-analog converter (DAC). The DAC can use an inverse Fourier transform (e.g., IDCT, IDFT, IFFT). The DAC can be defined by an audio codec. In an example implementation, the second non-windowed transform function is an IDCT. The IDCT (e.g., a first IDCT, a first non-windowed IDCT, and the like) can be configured to generate scalar values which are the analog or time-domain magnitudes. The second time-domain audio signal block-based audio signal. A block-based audio signal can include samples (e.g., blocks) of the time-domain audio signal. The samples can be sequential temporal frames, each frame can include a portion of the time-domain audio signal. Accordingly, the second time-domain audio signal can be one of a plurality of block-based audio signals (e.g., analog or time domain audio signals).

In step S825 a reconstructed time-domain audio signal is generated based on the second time-domain audio signal. For example, each of the plurality of block-based audio signals can be concatenated together on a sequential basis. The sequentially concatenated time-domain audio signals can be the reconstructed time-domain audio signal.

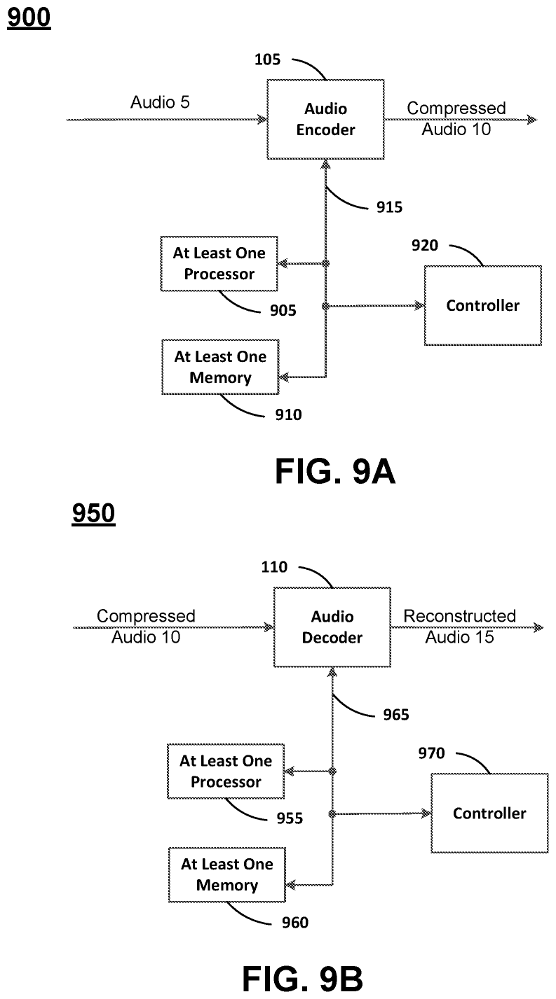

FIG. 9A illustrates a block diagram of an audio encoder according to an example implementation. In the example of FIG. 9A, an audio encoder system 900 may be at least one computing device and should be understood to represent virtually any computing device configured to perform the methods described herein. As such, the audio encoder system 900 may be understood to include various standard components which may be utilized to implement the techniques described herein, or different or future versions thereof.

FIG. 9A illustrates the audio encoder system 900 according to at least one example embodiment. As shown in FIG. 9A, the audio encoder system 900 includes the at least one processor 905, the at least one memory 910, a controller 920, and the audio encoder 105. The at least one processor 905, the at least one memory 910, the controller 920, and the audio encoder 105 are communicatively coupled via bus 915.

Thus, as may be appreciated, the at least one processor 905 may be utilized to execute instructions stored on the at least one memory 910, so as to thereby implement the various features and functions described herein, or additional or alternative features and functions. Of course, the at least one processor 905 and the at least one memory 910 may be utilized for various other purposes. In particular, the at least one memory 910 may be understood to represent an example of various types of memory and related hardware and software which might be used to implement any one of the modules described herein.

The at least one processor 905 may be configured to execute computer instructions associated with the controller 920 and/or the audio encoder 105. The at least one processor 905 may be a shared resource. For example, the audio encoder system 900 may be an element of a larger system (e.g., a streaming server). Therefore, the at least one processor 905 may be configured to execute computer instructions associated with other elements (e.g., a streaming server streaming audio) within the larger system.

The at least one memory 910 may be configured to store data and/or information associated with the audio encoder system 900. For example, the at least one memory 910 may be configured to store audio codecs. The controller 920 may be configured to generate various control signals and communicate the control signals to various blocks in audio encoder system 900. The controller 920 may be configured to generate the control signals in accordance with the techniques described above.

FIG. 9B illustrates a block diagram of an audio decoder according to an example implementation. In the example of FIG. 9B, an audio decoder system 950 may be at least one computing device and should be understood to represent virtually any computing device configured to perform the methods described herein. As such, the audio decoder system 950 may be understood to include various standard components which may be utilized to implement the techniques described herein, or different or future versions thereof. As shown in FIG. 9B, the audio decoder system 950 includes the at least one processor 955, the at least one memory 960, a controller 970, and the audio decoder 110. The at least one processor 955, the at least one memory 960, the controller 970, and the audio decoder 110 are communicatively coupled via bus 965.

The at least one processor 955 may be utilized to execute instructions stored on the at least one memory 960, so as to thereby implement the various features and functions described herein, or additional or alternative features and functions. Of course, the at least one processor 955 and the at least one memory 960 may be utilized for various other purposes. In particular, the at least one memory 960 may be understood to represent an example of various types of memory and related hardware and software which might be used to implement any one of the modules described herein. According to example embodiments, the audio encoder system 900 and the audio decoder system 950 may be included in a same larger system. Further, the at least one processor 905 and the at least one processor 955 may be a same at least one processor and the at least one memory 910 and the at least one memory 960 may be a same at least one memory. Still further, the controller 920 and the controller 970 may be a same controller.

The at least one processor 955 may be configured to execute computer instructions associated with the controller 970 and/or the audio decoder 110. The at least one processor 955 may be a shared resource. For example, the audio decoder system 950 may be an element of a larger system (e.g., a mobile device). Therefore, the at least one processor 955 may be configured to execute computer instructions associated with other elements (e.g., web browsing or wireless communication) within the larger system.

The at least one memory 960 may be configured to store data and/or information associated with the audio decoder system 950. The controller 970 may be configured to generate various control signals and communicate the control signals to various blocks in audio decoder system 950. The controller 970 may be configured to generate the control signals in accordance with the techniques described above.

Implementations can include one or more, and/or combinations thereof, of the following examples.

Example 1. A method including receiving a time-domain audio signal, generating a blocked time-domain audio signal as a portion of the time-domain audio signal, transforming the blocked time-domain audio signal using a first non-windowed transform function to generate a first frequency-domain audio signal, transforming the first frequency-domain audio signal using a second non-windowed transform function to generate a second frequency-domain audio signal, and compressing the second frequency-domain audio signal to generate a compressed frequency-domain audio signal.

Example 2. The method of Example 1, wherein the first non-windowed transform function can be a discrete cosine transform (DCT) transform.

Example 3. The method of Example 1 or Example 2 can further include generating a quantized frequency-domain audio signal by quantizing the second frequency-domain audio signal, wherein the compressing of the second frequency-domain audio signal can include compressing the quantized frequency-domain audio signal, the second frequency-domain audio signal can include a plurality of transform coefficient values, quantizing the second frequency-domain audio signal can include mapping each of plurality of transform coefficient values to one of a plurality of quantized transform coefficient values, and the mapping each of the plurality of transform coefficient values to one of the quantized transform coefficient values can include introducing an error to each quantized transform coefficient value.

Example 4. The method of Example 3, wherein the quantizing of the second frequency-domain audio signal can includes selecting a transform coefficient from a first mapped position, identifying a second mapped position adjacent to the first mapped position, and mapping the transform coefficient to the second mapped position.

Example 5. The method of Example 4, wherein the selecting of the transform coefficient can be based on an error associated with the quantized transform coefficient value corresponding to the transform coefficient.

Example 6. The method of Example 4, wherein the mapping of the transform coefficient to the second mapped position can include repeatedly selecting and mapping the transform coefficient to the second mapped position until an error is less than a threshold value.

Example 7. The method of Example 4, wherein the mapping of the first transform coefficient to the second mapped position can include identifying a subset of the plurality of quantized transform coefficient values, identifying the first mapped position as within the subset of the plurality of quantized transform coefficient values, and the second mapped position is within the subset of the plurality of quantized transform coefficient values.

Example 8. The method of any of Example 1 to Example 7, can further include one of storing the compressed frequency-domain audio signal in a computer memory or streaming the compressed frequency-domain audio signal.

Example 9. A method including receiving a formatted data packet including a compressed frequency-domain audio signal, generating a decompressed frequency-domain audio signal by decompressing the compressed frequency-domain audio signal, transforming the decompressed frequency-domain audio signal using a first non-windowed transform function to generate a first time-domain audio signal, transforming the first time-domain audio signal using a second non-windowed transform function to generate a second time-domain audio signal, and generating a reconstructed time-domain audio signal based on the second time-domain audio signal.

Example 10. The method of Example 9, wherein the first non-windowed transform function can be a discrete cosine transform (DCT) transform.

Example 11. The method of Example 9 or Example 10 can further include generating an inverse-quantized frequency-domain audio signal by inverse-quantizing the decompressed frequency-domain audio signal, wherein the quantizing of the decompressed frequency-domain audio signal can include calculating an alternating sum of a first block of the decompressed frequency-domain audio signal, calculating a sum of a second block of the decompressed frequency-domain audio signal, and repeatedly remapping values of the second block of the decompressed frequency-domain audio signal until the sum of the second block of the decompressed frequency-domain audio signal is within a threshold value of the alternating sum of the first block of the decompressed frequency-domain audio signal.

Example 12. The method of Example 11, wherein prior to the calculating of the alternating sum of the first block of the decompressed frequency-domain audio signal, the method can further include identifying a range of frequencies associated with the decompressed frequency-domain audio signal, the calculating of the alternating sum of the first block of the decompressed frequency-domain audio signal is calculated within the range of frequencies, and the calculating of the alternating sum of the second block of the decompressed frequency-domain audio signal is calculated within the range of frequencies.

Example 13. The method of Example 9 or Example 10 can further include generating an inverse-quantized frequency-domain audio signal by inverse-quantizing the decompressed frequency-domain audio signal, wherein the quantizing of the decompressed frequency-domain audio signal includes calculating an alternating sum of a first block of the decompressed frequency-domain audio signal, reversing an element order of a second block of the decompressed frequency-domain audio signal, calculating an alternating sum of the second block of the decompressed frequency-domain audio signal, and repeatedly remapping values of the second block of the decompressed frequency-domain audio signal until the sum of the second block of the decompressed frequency-domain audio signal is within a threshold value of the alternating sum of the first block of the decompressed frequency-domain audio signal.

Example 14. The method of Example 9 or Example 10 can further include generating an inverse-quantized frequency-domain audio signal by inverse-quantizing the decompressed frequency-domain audio signal, wherein the quantizing of the decompressed frequency-domain audio signal includes reversing an element order of a first block of the decompressed frequency-domain audio signal, calculating a sum of the first block of the decompressed frequency-domain audio signal, calculating a sum of a second block of the decompressed frequency-domain audio signal, and repeatedly remapping values of the second block of the decompressed frequency-domain audio signal until the sum of the second block of the decompressed frequency-domain audio signal is within a threshold value of the alternating sum of the first block of the decompressed frequency-domain audio signal.

Example 15. The method of Example 9 to Example 12 can further include playing back the reconstructed time-domain audio signal.

Example 16. A method can include any combination of one or more of Example 1 to Example 15.

Example 17. A non-transitory computer-readable storage medium comprising instructions stored thereon that, when executed by at least one processor, are configured to cause a computing system to perform the method of any of Examples 1-15.

Example 18. An apparatus comprising means for performing the method of any of Examples 1-15.

Example 19. An apparatus comprising at least one processor and at least one memory including computer program code, the at least one memory and the computer program code configured to, with the at least one processor, cause the apparatus at least to perform the method of any of Examples 1-15.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well: for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application- specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

1. A method comprising:
receiving a time-domain audio signal;
generating a blocked time-domain audio signal as a portion of the time-domain audio signal;
transforming the blocked time-domain audio signal using a first non-windowed transform function to generate a first frequency-domain audio signal;
transforming the first frequency-domain audio signal using a second non-windowed transform function to generate a second frequency-domain audio signal; and
compressing the second frequency-domain audio signal to generate a compressed frequency-domain audio signal.

2. The method of claim 1, wherein the first non-windowed transform function is a discrete cosine transform (DCT) transform.

3. The method of claim 1, further comprising:
generating a quantized frequency-domain audio signal by quantizing the second frequency-domain audio signal, wherein:
the compressing of the second frequency-domain audio signal includes compressing the quantized frequency-domain audio signal,
the second frequency-domain audio signal includes a plurality of transform coefficient values,
quantizing the second frequency-domain audio signal includes mapping each of plurality of transform coefficient values to one of a plurality of quantized transform coefficient values, and
the mapping each of the plurality of transform coefficient values to one of the quantized transform coefficient values includes introducing an error to each quantized transform coefficient value.

4. The method of claim 3, wherein the quantizing of the second frequency-domain audio signal includes:
selecting a transform coefficient from a first mapped position,
identifying a second mapped position adjacent to the first mapped position, and
mapping the transform coefficient to the second mapped position.

5. The method of claim 4, wherein the selecting of the transform coefficient is based on an error associated with the quantized transform coefficient value corresponding to the transform coefficient.

6. The method of claim 4, wherein the mapping of the transform coefficient to the second mapped position includes repeatedly selecting and mapping the transform coefficient to the second mapped position until an error is less than a threshold value.

7. The method of claim 4, wherein the mapping of the first transform coefficient to the second mapped position includes:
identifying a subset of the plurality of quantized transform coefficient values,
identifying the first mapped position as within the subset of the plurality of quantized transform coefficient values, and
the second mapped position is within the subset of the plurality of quantized transform coefficient values.

8. The method of claim 1, further comprising one of:
storing the compressed frequency-domain audio signal in a computer memory, or
streaming the compressed frequency-domain audio signal.

9. A method comprising:
receiving a formatted data packet including a compressed frequency-domain audio signal;
generating a decompressed frequency-domain audio signal by decompressing the compressed frequency-domain audio signal;
transforming the decompressed frequency-domain audio signal using a first non-windowed transform function to generate a first time-domain audio signal;
transforming the first time-domain audio signal using a second non-windowed transform function to generate a second time-domain audio signal; and
generating a reconstructed time-domain audio signal based on the second time-domain audio signal.

10. The method of claim 9, wherein the first non-windowed transform function is a discrete cosine transform (DCT) transform.

11. The method of claim 9, further comprising:
generating an inverse-quantized frequency-domain audio signal by inverse-quantizing the decompressed frequency-domain audio signal, wherein the quantizing of the decompressed frequency-domain audio signal includes:
calculating an alternating sum of a first block of the decompressed frequency-domain audio signal,
calculating a sum of a second block of the decompressed frequency-domain audio signal, and
repeatedly remapping values of the second block of the decompressed frequency-domain audio signal until the sum of the second block of the decompressed frequency-domain audio signal is within a threshold value of the alternating sum of the first block of the decompressed frequency-domain audio signal.

12. The method of claim 11, wherein:
prior to the calculating of the alternating sum of the first block of the decompressed frequency-domain audio signal, the method further comprising:
identifying a range of frequencies associated with the decompressed frequency-domain audio signal,
the calculating of the alternating sum of the first block of the decompressed frequency-domain audio signal is calculated within the range of frequencies, and
the calculating of the alternating sum of the second block of the decompressed frequency-domain audio signal is calculated within the range of frequencies.

13. The method of claim 9, further comprising:
generating an inverse-quantized frequency-domain audio signal by inverse-quantizing the decompressed frequency-domain audio signal, wherein the quantizing of the decompressed frequency-domain audio signal includes:
calculating an alternating sum of a first block of the decompressed frequency-domain audio signal,
reversing an element order of a second block of the decompressed frequency-domain audio signal,
calculating an alternating sum of the second block of the decompressed frequency-domain audio signal, and
repeatedly remapping values of the second block of the decompressed frequency-domain audio signal until the sum of the second block of the decompressed frequency-domain audio signal is within a threshold value of the alternating sum of the first block of the decompressed frequency-domain audio signal.

14. The method of claim 9, further comprising:
generating an inverse-quantized frequency-domain audio signal by inverse-quantizing the decompressed frequency-domain audio signal, wherein the quantizing of the decompressed frequency-domain audio signal includes:
reversing an element order of a first block of the decompressed frequency-domain audio signal,
calculating a sum of the first block of the decompressed frequency-domain audio signal,
calculating a sum of a second block of the decompressed frequency-domain audio signal, and
repeatedly remapping values of the second block of the decompressed frequency-domain audio signal until the sum of the second block of the decompressed frequency-domain audio signal is within a threshold value of the sum of the first block of the decompressed frequency-domain audio signal.

15. The method of claim 9, further comprising playing back the reconstructed time-domain audio signal.

16. A method comprising:
generating a blocked time-domain audio signal as a portion of a time-domain audio signal;
transforming the blocked time-domain audio signal using a first non-windowed transform function to generate a first frequency-domain audio signal;
transforming the first frequency-domain audio signal using a second non-windowed transform function to generate a second frequency-domain audio signal;
compressing the second frequency-domain audio signal to generate a compressed frequency-domain audio signal;
generating a decompressed frequency-domain audio signal by decompressing the compressed frequency-domain audio signal;
transforming the decompressed frequency-domain audio signal using a third non-windowed transform function to generate a third time-domain audio signal;
transforming the third time-domain audio signal using a fourth non-windowed transform function to generate a fourth time-domain audio signal; and
generating a reconstructed time-domain audio signal based on the fourth time-domain audio signal.

17. The method of claim 16, further comprising:
generating a quantized frequency-domain audio signal by quantizing the second frequency-domain audio signal, wherein:
the compressing of the second frequency-domain audio signal includes compressing the quantized frequency-domain audio signal,
the second frequency-domain audio signal includes a plurality of transform coefficient values,
quantizing the second frequency-domain audio signal includes mapping each of plurality of transform coefficient values to one of a plurality of quantized transform coefficient values, and
the mapping each of the plurality of transform coefficient values to one of the quantized transform coefficient values includes introducing an error to each quantized transform coefficient value.

18. The method of claim 17, wherein the quantizing of the second frequency-domain audio signal includes:
selecting a transform coefficient from a first mapped position,
identifying a second mapped position adjacent to the first mapped position, and
mapping the transform coefficient to the second mapped position.

19. The method of claim 18, wherein the selecting of the transform coefficient is based on an error associated with the quantized transform coefficient value corresponding to the transform coefficient.

20. The method of claim 16, further comprising:
generating an inverse-quantized frequency-domain audio signal by inverse-quantizing the decompressed frequency-domain audio signal, wherein the quantizing of the decompressed frequency-domain audio signal includes:
calculating an alternating sum of a first block of the decompressed frequency-domain audio signal,
calculating a sum of a second block of the decompressed frequency-domain audio signal, and
repeatedly remapping values of the second block of the decompressed frequency-domain audio signal until the sum of the second block of the decompressed frequency-domain audio signal is within a threshold value of the alternating sum of the first block of the decompressed frequency-domain audio signal.

21. The method of claim 20, wherein:
prior to the calculating of the alternating sum of the first block of the decompressed frequency-domain audio signal,
identifying a range of frequencies associated with the decompressed frequency-domain audio signal,
the calculating of the alternating sum of the first block of the decompressed frequency-domain audio signal is calculated within the range of frequencies, and
the calculating of the alternating sum of the second block of the decompressed frequency-domain audio signal is calculated within the range of frequencies.

22. The method of claim 20, further comprising:
generating an inverse-quantized frequency-domain audio signal by inverse-quantizing the decompressed frequency-domain audio signal, wherein the quantizing of the decompressed frequency-domain audio signal includes:
calculating an alternating sum of a first block of the decompressed frequency-domain audio signal,
reversing an element order of a second block of the decompressed frequency-domain audio signal,
calculating an alternating sum of the second block of the decompressed frequency-domain audio signal, and
repeatedly remapping values of the second block of the decompressed frequency-domain audio signal until the sum of the second block of the decompressed frequency-domain audio signal is within a threshold value of the alternating sum of the first block of the decompressed frequency-domain audio signal.

23. The method of claim 20, further comprising:
generating an inverse-quantized frequency-domain audio signal by inverse-quantizing the decompressed frequency-domain audio signal, wherein the quantizing of the decompressed frequency-domain audio signal includes:
reversing an element order of a first block of the decompressed frequency-domain audio signal,
calculating a sum of the first block of the decompressed frequency-domain audio signal,
calculating a sum of a second block of the decompressed frequency-domain audio signal, and
repeatedly remapping values of the second block of the decompressed frequency-domain audio signal until the sum of the second block of the decompressed frequency-domain audio signal is within a threshold value of the sum of the first block of the decompressed frequency-domain audio signal.

24. The method of claim 16, further comprising playing back the reconstructed time-domain audio signal.
